(19) United States
(12) Patent Application Publication
(10) Pub. No.: US 2011/0044447 A1
(43) Pub. Date: Feb. 24, 2011

(54) TREND DISCOVERY IN AUDIO SIGNALS

(75) Inventors: Robert W. Morris, Atlanta, GA (US); Marsal Gavalda, Sandy Springs, GA (US); Peter S. Cardillo, Atlanta, GA (US); Jon A. Arrowood, Smyrna, GA (US)

Correspondence Address: OCCHIUTI ROHLICEK & TSAO, LLP, 10 FAWCETT STREET, CAMBRIDGE, MA, 02138, US

(73) Assignee: Nexidia Inc., Atlanta, GA (US)

(21) Appl. No.: 12/545,282

(22) Filed: Aug. 21, 2009

(51) Int. Cl. H04M 3/00; G10L 15/00; G06T 11/20

(52) U.S. Cl. 379/265.03; 704/231; 345/440; 704/E15.001

(57) ABSTRACT

Techniques for processing data representative of text associated with one or more content sources to generate a specification of a set of keyphrases of interest; processing a first set of audio signals collected during a first time period to generate first data characterizing putative occurrences of one or more keyphrases of the set in the first set of audio signals; evaluating the first data to generate keyphrase-specific comparison values for the first set of audio signals; deriving first trending data between the first set of audio signals and a second set of audio signals based in part on an analysis of the keyphrase-specific comparison values for the first set of audio signals relative to stored keyphrase-specific baseline values; and generating a visual representation of at least some of the first trending data and causing the visual representation of the first trending data to be presented on a display terminal.

### CROSS-REFERENCE TO RELATED APPLICATIONS

This application is related to the following patent applications, the contents of which are incorporated herein by reference: application Ser. No. 12/490,757, filed Jun. 24, 2009, and entitled “Enhancing Call Center Performance” (Attorney Docket No. 30004-041001); Provisional Application Ser. No. 61/231,758, filed Aug. 6, 2009, and entitled “Real-Time Agent Assistance” (Attorney Docket No. 30004-042P01); and Provisional Application Ser. No. 61/219,983, filed Jun. 24, 2009, and entitled “Enterprise speech intelligence analysis” (Attorney Docket No. 30004-043P01).

### BACKGROUND

This description relates to trend discovery in audio signals.

A contact center provides a communication channel through which business entities can manage their customer contacts. In addition to handling various customer requests, a contact center can be used to deliver valuable information about a company to appropriate customers and to aggregate customer data for making business decisions. Improving the efficiency and effectiveness of agent-customer interactions can result in greater customer satisfaction, reduced operational costs, and more successful business processes.

### SUMMARY

In a general aspect, a method includes processing, by a keyphrase generation engine, data representative of text associated with one or more content sources to generate a specification of a set of keyphrases of interest; processing, by a word spotting engine, a first set of audio signals collected during a first time period to generate first data characterizing putative occurrences of one or more keyphrases of the set of keyphrases of interest in the first set of audio signals; evaluating, by an analysis engine, the first data to generate keyphrase-specific comparison values for the first set of audio signals; deriving, by the analysis engine, first trending data between the first set of audio signals and a second set of audio signals based in part on an analysis of the keyphrase-specific comparison values for the first set of audio signals relative to stored keyphrase-specific baseline values; and generating, by a user interface engine, a visual representation of at least some of the first trending data and causing the visual representation of the first trending data to be presented on a display terminal.

Embodiments may include one or more of the following. The visual representation further includes trending data other than the first trending data. The keyphrase generation engine, the word spotting engine, the analysis engine, and the user interface engine form part of a contact center system. The first set of audio signals is representative of interactions between contact center callers and contact center agents. The display terminal is associated with a contact center user.

The method further includes processing, by the word spotting engine, the second set of audio signals collected during a second time period to generate second data characterizing putative occurrences of one or more keyphrases of the set of keyphrases of interest in the second set of audio signals. The second set of audio signals is representative of interactions between contact center callers and contact center agents. The second time period is prior to the first time period, and the method further includes evaluating, by the analysis engine, the second data to generate the keyphrase-specific baseline values; and storing, by the analysis engine, the keyphrase-specific baseline values in a machine-readable data store.

The second time period is subsequent to the first time period, and the method further includes evaluating, by the analysis engine, the second data to generate keyphrase-specific comparison values for the second set of audio signals; deriving, by the analysis engine, second trending data between the second set of audio signals period and a third set of audio signals based in part on an analysis of the keyphrase-specific comparison values of the second set of audio signals relative to the stored keyphrase-specific baseline values; and generating, by the user interface engine, a visual representation of at least some of the second trending data and causing the visual representation of the second trending data to be presented on a display terminal.

The second time period is subsequent to the first time period, and the method further includes evaluating, by the analysis engine, the second data to generate keyphrase-specific comparison values for the second set of audio signals; deriving, by the analysis engine, second trending data between the second set of audio signals and the first set of audio signals based in part on an analysis of the keyphrase-specific comparison values of the second set of audio signals relative to the keyphrase-specific comparison values for the first set of audio signals; and generating, by the user interface engine, a visual representation of at least some of the second trending data and causing the visual representation of the second trending data to be presented on a display terminal.

The specification of the set of keyphrases of interest includes at least one phonetic representation of each keyphrase of the set. For each set of audio signals, the processing includes identifying time locations in the set of audio signals at which a spoken instance of a keyphrase of the set of keyphrases of interest is likely to have occurred based on a comparison of data representing the set of audio signals with the specification of the set of keyphrases of interest. Evaluating each of the first data and the second data includes computing values representative of one or more of the following: hit count, call count, call percentage, total call duration. The method further includes filtering the first set of audio signals prior to processing the first set of audio signals by the word spotting engine. The filtering is based on one or more of the following techniques: clip spotting and natural language processing.

In another general aspect, a method includes processing, by a keyphrase generation engine, data representative of text associated with one or more content sources to generate a specification of a set of keyphrases of interest; processing, by a word spotting engine, a first set of audio signals collected during a first time period to generate first data characterizing putative occurrences of one or more keyphrases of the set of keyphrases of interest in the first set of audio signals; evaluating, by an analysis engine, the first data to identify coocurrences of spoken instances of keyphrases of the set of keyphrases of interest within the first set of audio signals; and generating, by a user interface engine, a visual representation of at least some of the identified cooccurences of the spoken instances of keyphrases and causing the visual representation to be presented on a display terminal.

Embodiments may include one or more of the following. The identified cooccurrences of spoken instances of keyphrases represent salient pairs of cooccurring keyphrases of interest. The method further includes deriving, by the analysis engine, first trending data between the first set of audio signals and a second set of audio signals based in part on an analysis of the salient pairs of coocurring keyphrases of interest within the first set of audio signals relative to salient pairs of coocurring keyphrases of interest within a second set of audio signals, and generating, by the user interface engine, a visual representation of at least some of the first trending data and causing the visual representation of the first trending data to be presented on the display terminal. The visual representation further includes trending data other than the first trending data.

The identified coocurrences of spoken instances of keyphrases represent clusters of keyphrases of interest. The method further includes deriving, by the analysis engine, first trending data between the first set of audio signals and a second set of audio signals based in part on an analysis of the clusters of keyphrases of interest within the first set of audio signals relative to clusters of coocurring keyphrases of interest within a second set of audio signals; and generating, by the user interface engine, a visual representation of at least some of the first trending data and causing the visual representation of the first trending data to be presented on the display terminal.

The keyphrase generation engine, the word spotting engine, the analysis engine, and the user interface engine form part of a contact center system. The first set of audio signals is representative of interactions between contact center callers and contact center agents. The display terminal is associated with a contact center user.

Evaluating the first data includes recording a number of times a spoken instance of a first keyphrase of the set of keyphrases of interest occurs within a predetermined range of another keyphrase of the set of keyphrases of interest; generating a vector for the first keyphrase based on the recording; and storing the generated first keyphrase vector in a machine-readable data store for further processing. The method further includes repeating the recording, vector generating, and storing actions for at least some other keyphrases of the set of keyphrases of interest.

In general, the techniques described in this document can be applied in many contact center contexts to ultimately benefit both contact center performance and caller experience. Trend discovery techniques are capable of identifying meaningful words and phrases using the high speed and high recall of phonetic indexing analysis. The vocabulary can be automatically refreshed and expanded as new textual sources become available without the need for user intervention. Trend discovery analyzes millions of spoken phrases to automatically detect emerging trends that may not be apparent to a user. The integration of call metadata adds relevance to the results of an analysis by including call parameters such as handle times, repeat call patterns, and other important metrics. Trend discovery provides an initial narrative into control center activity by highlighting important topics and generating clear visualizations of the results. These techniques thus help decision makers in choosing where to focus further empirical analysis of calls.

Other features and advantages of the invention are apparent from the following description and from the claims.

### BRIEF DESCRIPTION OF DRAWINGS

FIG. 1 shows a block diagram of a data management system.

FIG. 2 is a flowchart of a method for discovering trends in a set of audio signals.

FIG. 3 is a flowchart of a trend discovery analysis.

FIG. 4 is a flowchart of a two-stage search process to locate keyphrases of interest in audio data.

FIGS. 5A and 5B are word cloud representations of keyphrases of interest that, respectively, appeared in and disappeared from a listing of keyphrases of interest in audio data between two periods of time.

FIGS. 5C and 5D are word cloud representations of keyphrases of interest that, respectively, increased and decreased in rank in a listing of top keyphrase of interest in audio data between two periods of time.

FIGS. 6A and 6B are a word cloud representation and a bar chart, respectively, showing changes in a frequency of occurrence of top keyphrases of interest.

FIGS. 7A and 7B are a word cloud representation and a bar chart, respectively, showing increases and decreases in rank of top keyphrases of interest.

FIGS. 8A and 8B show interactive displays of trends in top keyphrases of interest.

FIG. 9 is a user interface for viewing trends in keyphrases of interest.

FIG. 10 is a flow chart of a process for detecting salient pairs of co-occurring keyphrases of interest.

FIGS. 11A-11C show a user interface for viewing co-occurring keyphrases of interest and clusters of keyphrases of interest.

FIG. 12 shows a representation of co-occurring keyphrases of interest and clusters of keyphrases of interest.

FIGS. 13A and 13B are word cloud representations of keyphrases of interest detected in a text source using a generic language model (LM) and a custom LM, respectively.

FIG. 14 is a block diagram of an example of a contact center service platform with integrated call monitoring and analysis.

### DETAILED DESCRIPTION

### 1 Overview

The following description discusses techniques and approaches that can be applied for discovering trends in sets of audio signals. For purposes of illustration and without limitation, the techniques are illustrated in detail below in the context of customer interactions with control centers. In this context, trend discovery identifies and tracks trends in topics discussed in those customer interactions. The identified trends highlight critical issues in a control center, such as common customer concerns, and serve as a starting point for a more in-depth analysis of a particular topic. For instance, trend discovery helps decision makers to gauge the success of a newly introduced promotion by tracking the frequency with which that promotion is mentioned during phone calls. The analytic tools provided by trend discovery thus add significant business value to control centers.

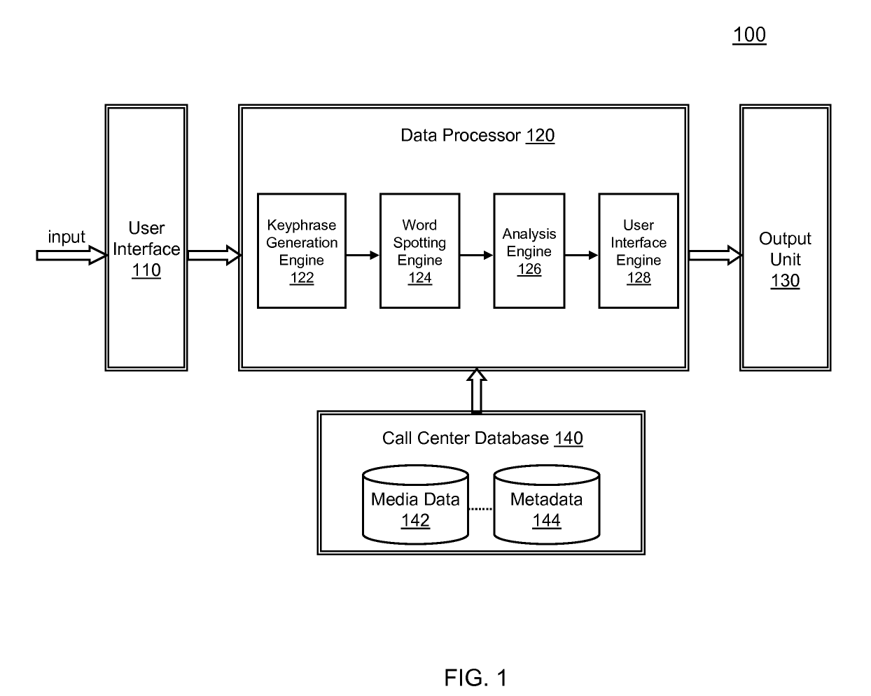

Referring to FIG. 1, a data management system 100 includes a data processor 120 for performing various types of user-directed analyses relating to trend discovery. Very generally, the data management system 100 includes a user interface 110 for accepting input from a user (e.g., an agent, a supervisor, or a manager) to define the scope of data to be investigated and the rules by which the investigation will be conducted. The input is provided to the data processor 120, which subsequently accesses a control center database 140 to obtain and analyze selected segments of data according to the user-defined rules.

Generally, the database 140 includes media data 142, for example, voice recordings of past and present calls handled by agents. The database 140 also includes metadata 144, which contains descriptive, non-audio data stored in association with audio data 142. Examples of metadata 144 include phonetic audio track (PAT) files that provide a searchable phonetic representation of the media data, transcripts of the media data, and descriptive information such as customer identifiers, customer characteristics (e.g., gender), agent identifiers, call durations, transfer records, day and time of a call, general categorization of calls (e.g., payment vs. technical support), agent notes, and customer-inputted dual-tone multi-frequency (DTMF; i.e., touch-tone) tones.

By processing data maintained in the control center database 140, the data processor 120 can extract management-relevant information for use in a wide range of analyses, including for example:
monitoring key metrics indicative of customer satisfaction/dissatisfaction;
identifying anomalies that require investigation;
identifying trends;
correlating results to support root cause analysis;
gaining insights on the performance of individual agents and groups of agents; and
accessing user information using tool-tips and drill down to specific media files.

Results of these analyses can be presented to the user in desired forms through an output unit 130 (e.g. on a computer screen), allowing user interactions through the user interface 110 for further analysis and processing of the data if needed.

In some embodiments, data processor 120 includes a set of engines that detect trends in audio data. Those engines include a keyphrase generation engine 122, a word spotting engine 124, an analysis engine 126, and a user interface engine 128, as described in detail below.

### 2 Trend Discovery

### 2.1 Analysis

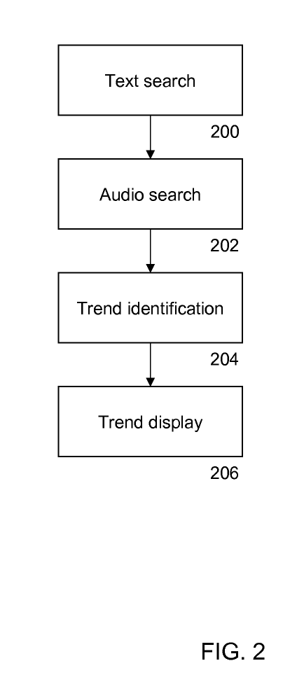

Referring to FIG. 2, in general, the process of trend discovery can be divided into four basic steps. In a first step, text sources are searched (200) to generate a list of keyphrases of interest, which are single- or multi-word phrases, such as “ridiculous,” “apologize,” “billing address,” “text messaging,” or “phone number,” that occur frequently in the text sources. Audio sources are then automatically searched (202) for occurrences of the keyphrases of interest. Trends in keyphrase occurrence in the audio sources are identified (204) based on the frequency of occurrence (i.e., hit count) of a keyphrase or on call metadata parameters such as call count, call percentage, or total call duration for calls including a particular keyphrase. The trends are then presented (206) to a user graphically, in a text format, or with an animated visualization.

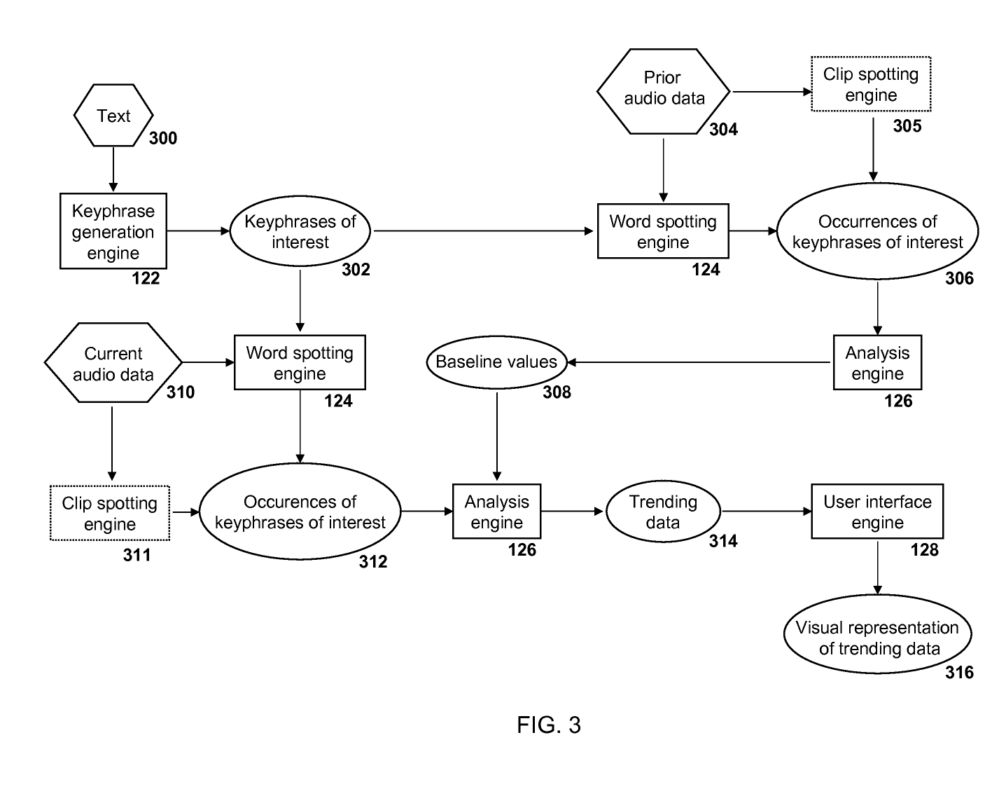

Referring to FIG. 3, keyphrase generation engine 122 processes a text corpus 300 to identify keyphrases of interest 302. Text corpus 300 includes text sources such as company training materials, promotional materials, websites, product literature, and technical support manuals relevant to a particular company, field or application. For instance, for a mobile phone company, examples of text sources include descriptions of mobile phone plans and coverage areas, user guides for telephones, training materials for customer service and technical support agents, and websites of the mobile phone company.

Keyphrase generation engine 122 uses conventional natural language processing techniques to identify keyphrases of interest. The keyphrase generation engine employs a language model (LM) that models word frequencies and context and that is trained from a large textual corpora. For instance, the LM may be trained on the Gigaword corpus, which includes 1.76 billion word tokens obtained from web pages. Keyphrase generation engine 122 applies the LM to text corpus 300 using natural language processing techniques to identify keyphrases of interest. For instance, the keyphrase generation engine may employ part-of-speech tagging, which automatically tags words or phrases in text corpus 300 with their grammatical categories according to lexicon and contextual rules. For instance, in the phrase “activated the phone,” the word “activated” is tagged as a past tense verb, the word “the” is tagged as a determiner, and the word “phone” is tagged as a singular noun. Keyphrase generation engine 122 may also use noun phrase chunking based on Hidden Markov Models or Transformation-Based Learning to locate noun phrases, such as “account management” or “this phone,” in the text corpus 300. Keyphrase generation engine 122 also applies rule-based filters to text corpus 300. Keyphrase generation engine 122 may also identify keyphrases of interest based on an analysis of the nature of a phrase given its constituent parts. The set of vocabulary identified as keyphrases of interest represents topics most likely to occur in audio signals (e.g., control center conversations) to be analyzed for trends.

Once keyphrases of interest 302 are identified in text corpus 300, prior audio data 304 are fed into word spotting engine 124. Prior audio data include stored searchable data (e.g., PAT data) representing, for instance, audio recordings of telephone calls made over a period of time. For control center applications, prior audio data 304 may include data for more than 20,000 calls made over a period of 13 weeks. Word spotting engine 124 receives keyphrases of interest 302 and evaluates prior audio data 304 to generate data 306 characterizing putative occurrences of one or more of the keyphrases of interest 302 in the prior audio data 304.

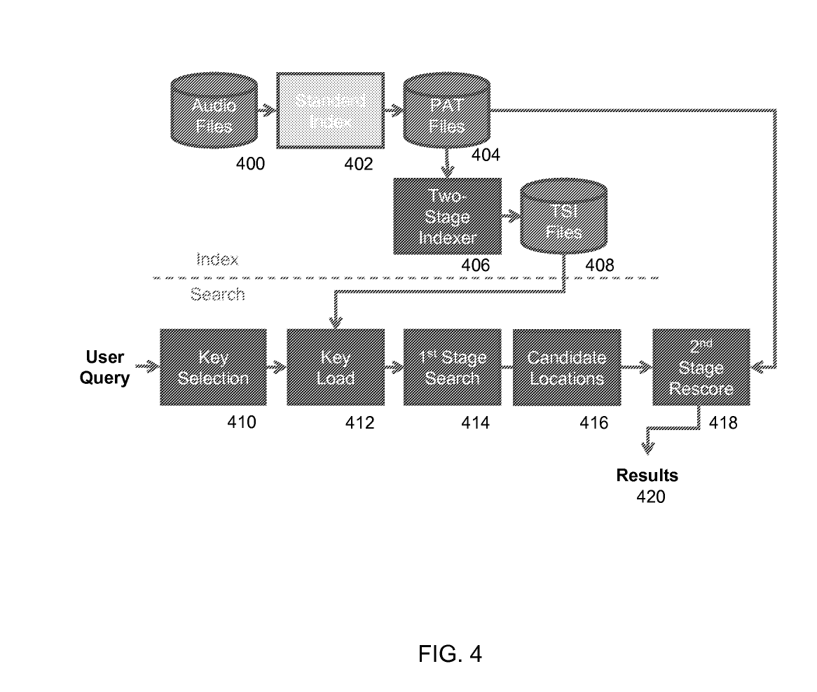

Referring to FIG. 4, a two-stage search is used to quickly and efficiently locate keyphrases of interest in audio data. As discussed above, a standard index engine 402 (e.g., keyphrase generation engine 122) converts an audio file 400 to a PAT file 404, which includes a searchable phonetic representation of the audio data in audio file 400. A two-stage indexer engine 406 pre-searches PAT file 404 for a large set of sub-word keys and stores the keys in a two-stage indexer (TSI) file 408 corresponding to the original PAT file 404. Independently, a user or, in a trend discovery application, a word spotting engine, selects a search key 410 (e.g., a keyphrase of interest). Search key 410 and TSI file 408 are loaded (412) into a first stage search engine 414, which searches TSI file 408 for candidate locations 416 where instance of search key 410 may occur. The candidate locations 416 are used to guide a focused search of PAT file 404 by a second stage rescore engine 418. A set of results 420 indicating occurrences of search key 140 in PAT file 404 is output by rescore engine 418. Using this two-stage search process, a rapid and high-volume search is possible. For instance, searching 100 million xRT per server, it is feasible to search 100,000 hours of audio files in 3.3 seconds.

Referring again to FIG. 3, the data 306 characterizing putative keyphrase occurrences is then evaluated by analysis engine 126, which generates keyphrase-specific baseline values representing a frequency of occurrence of each keyphrase in prior audio data 304. Analysis engine 126 may also generate baseline values 308 representing call metadata parameters such as a call count, call percentage, or total call duration for each keyphrase in prior audio data 304, which parameters are obtained from call metadata files. In some embodiments, baseline values 308 include a baseline score for each keyphrase of interest, which score is a function of a call parameter or a search term. The score for a given keyphrase approximates an actual likelihood of the keyphrase occurring in a set of audio signals. The baseline values 308 are stored by analysis engine in a data storage medium such as a hard drive.

Current audio data 310 corresponding to, for instance, recently completed telephone calls are received by word spotting engine 124. Current audio data 310 is searchable data, such as PAT files, representing audio signals. Word spotting engine 124 evaluates current audio data 310 to generate data 312 characterizing putative occurrences of one or more of the keyphrases of interest 302 in the current audio data 310. The data 312 characterizing putative keyphrase occurrences are then processed by analysis engine 126, which generates current keyphrase-specific comparison values relating to a frequency of occurrence, a call metadata parameter (such as call count, call percentage, or total call duration), or a score for each keyphrase in current audio data 310. Analysis engine 126 retrieves stored baseline data 308 and uses robust, non-parametric statistical analysis to compare baseline values 308 with the current keyphrase-specific comparison values to produce trending data 314. Comparisons may be made on the basis of a frequency of occurrence, a call metadata parameter, or a score for each keyphrase of interest.

Trending data 314 represents a rank or a change in a frequency of occurrence of a keyphrase of interest between prior audio data 304 and current audio data 310. Trending data 314 may also represent a change in a call parameter of keyphrases of interest 302. For instance, trending data 314 may include a ranking or change in ranking of top keyphrases of interest in a given time period, a listing of keyphrases that appeared or disappeared between two time periods, or a change in call duration for calls including a given keyphrase of interest.

In some instances, portions of prior and/or current audio data may not be relevant to an analysis of a set of audio signals. For instance, in control center applications, on-hold messages, such as advertising and promotions, and interactive voice response (IVR) messages skew the statistics of keyphrase detection and trend discovery. Automatically filtering out repeated segments, such as on-hold and IVR messages, by a clip spotting process (e.g., using optional clip spotting engines 305, 311 in FIG. 3) prior to analysis of the audio data focuses trend discovery on conversations between customers and control center agents. Similarly, in broadcast applications, advertising messages may be filtered out and removed from the analysis.

### 2.2 Visualization

Referring still to FIG. 3, user interface engine 128 generates a visual representation 316 of trending data 314 for display on a display terminal, such as a computer screen. For instance, trending data 314 may be displayed as word clouds, motion charts, graphs, or in tabular form. In some cases, the visual representation 316 includes links to recordings to play back (i.e., drill-down) corresponding audio files. User interface engine 128 also includes functionality allowing a user to set up email or text messaging alerts for particular situations in trending data 314.

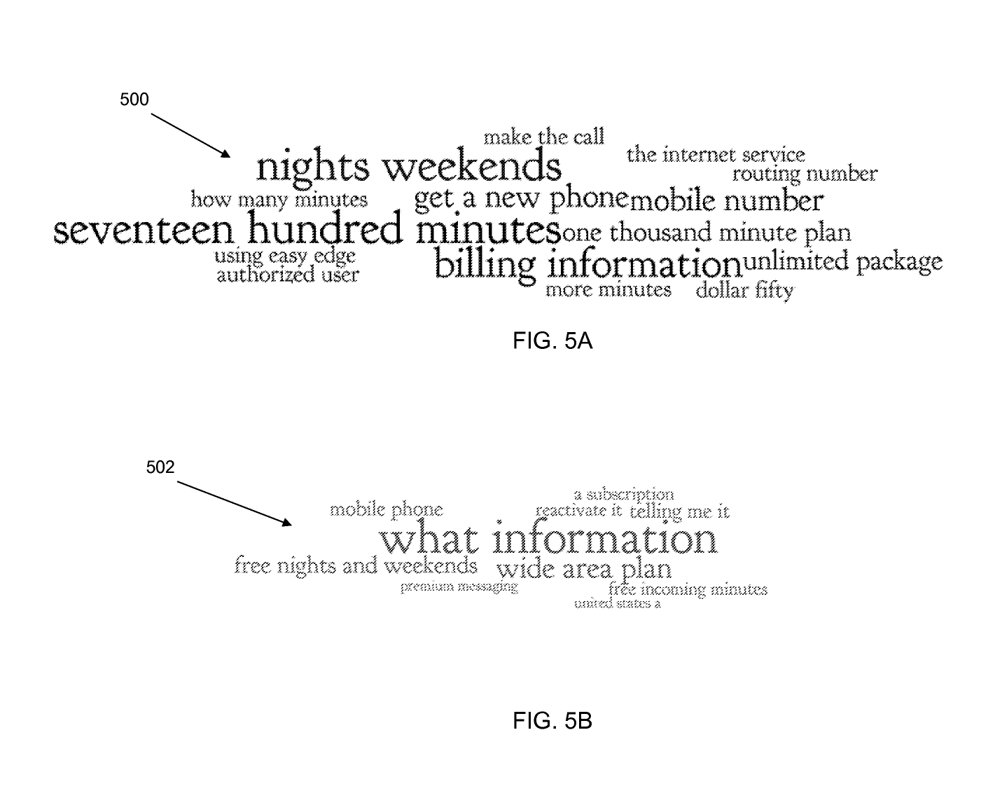

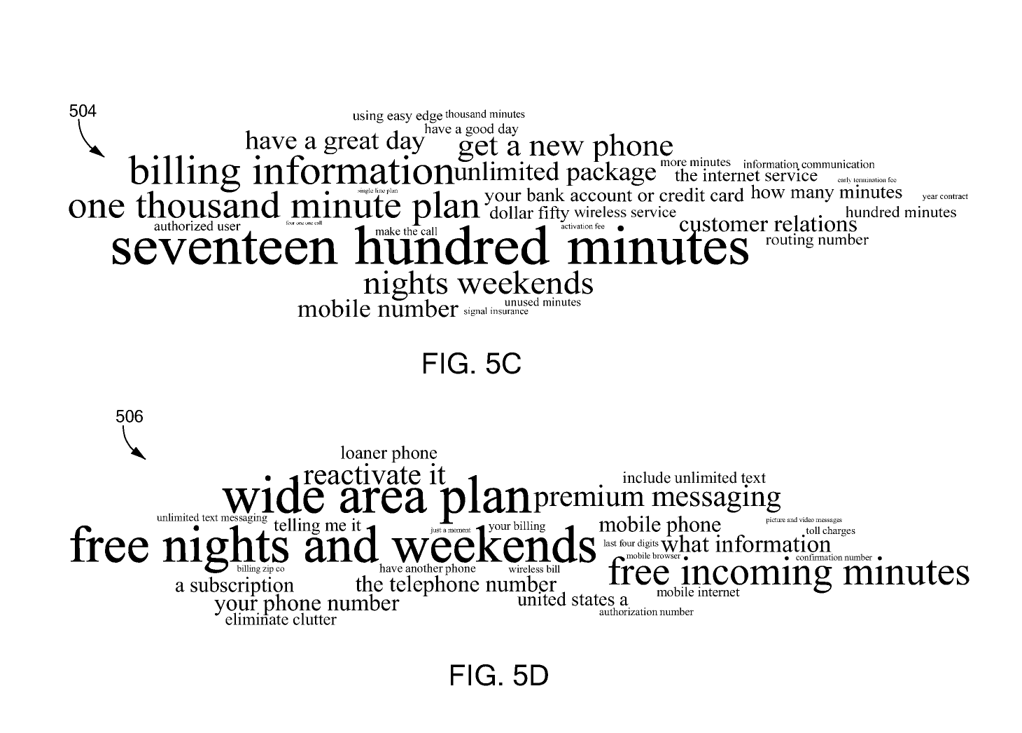

Referring to FIGS. 5A-5D, word clouds 500 and 502 show keyphrases of interest that, respectively, appeared in and disappeared from telephone calls to a control center in a selected week relative to telephone calls in a previous week. Similarly, word clouds 504 and 506 show keyphrases of interest that increased and decreased in rank, respectively, between the selected week and the previous week. The size of a keyphrase in the word cloud corresponds to its rank relative to other keyphrases. For instance, the phrase “seventeen hundred minutes” appeared as the top keyphrase of interest during the selected week, as seen in FIGS. 5A and 5C. In contrast, the phrase “free nights and weekends” disappeared as a top keyphrase of interest during the selected week, and its rank accordingly decreased, as seen in FIGS. 5B and 5D. The information shown in word clouds 500, 502, 504, and 506 is useful, for instance, in gauging the effect of a promotional “seventeen hundred minute” mobile phone plan introduced between the previous week and the selected week.

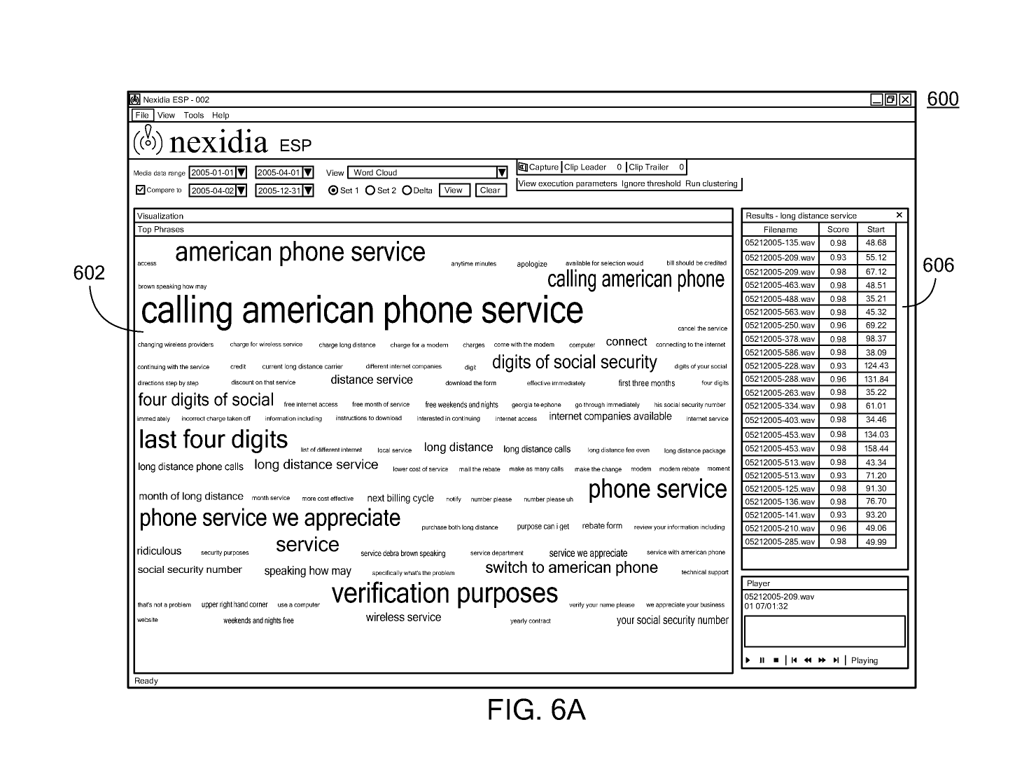

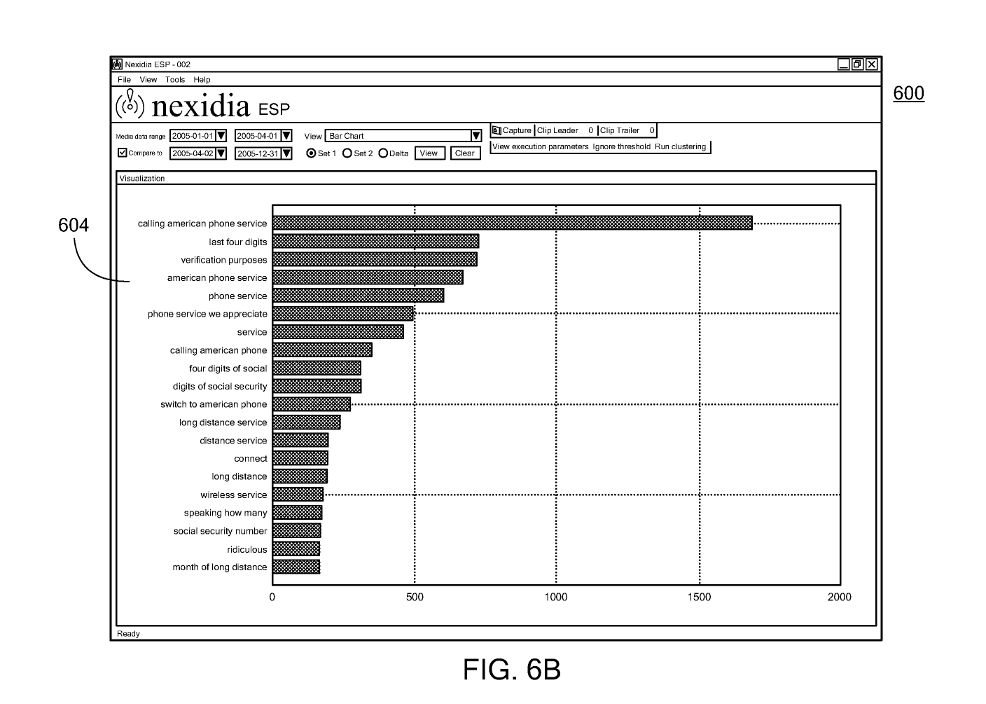

Referring to FIGS. 6A and 6B, a user interface 600 shows a word cloud 602 and a bar chart 604, respectively, showing changes in the frequency of occurrence of top keyphrases of interest between a first time period (Jan. 1, 2005-Apr. 1, 2005) and a second time period (Apr. 2, 2005-Dec. 31, 2005). In this example, the top keyphrase of interest is the phrase “calling american phone service.” A playback window 606 allows a user to listen to relevant audio files, such as audio files of a particular phone call.

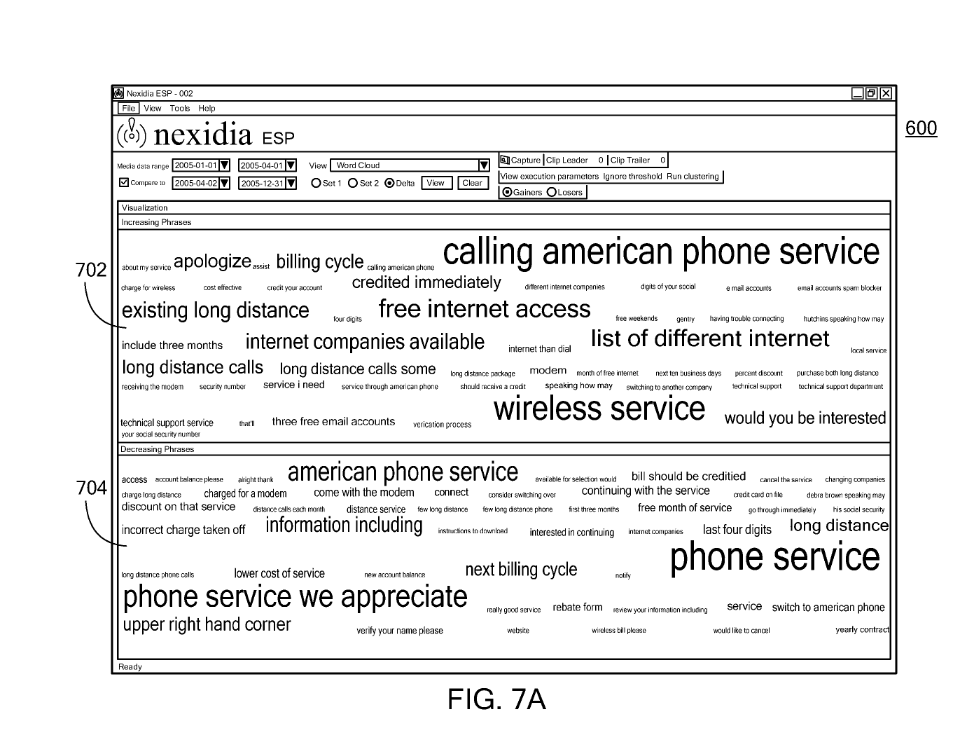

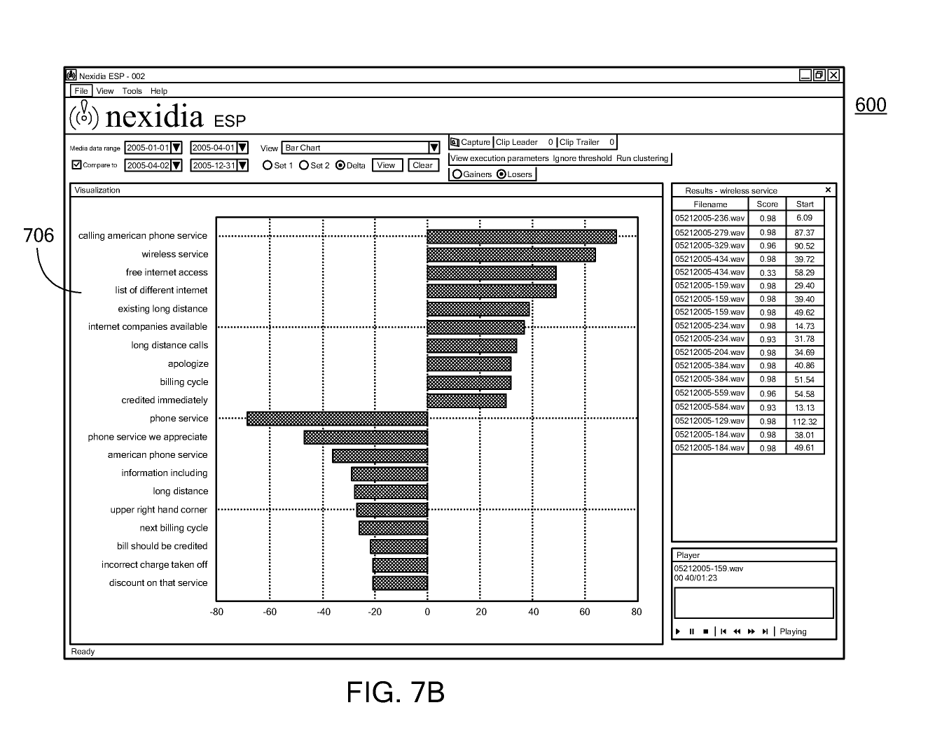

Referring to FIGS. 7A, user interface 600 shows word clouds 702 and 704 depicting increases and decreases in the rank of keyphrases of interest between a first time period (Jan. 1, 2005-Apr. 1, 2005) and a second time period (Apr. 2, 2005-Dec. 31, 2005). FIG. 7B shows a bar chart 706 of the same data. In this example, the keyphrase “calling american phone service” increased most in rank, occurring about 70% more frequently in the second time period as compared to the first time period. The keyphrase “phone service” decreased most in rank, occurring about 70% less often during the second time period.

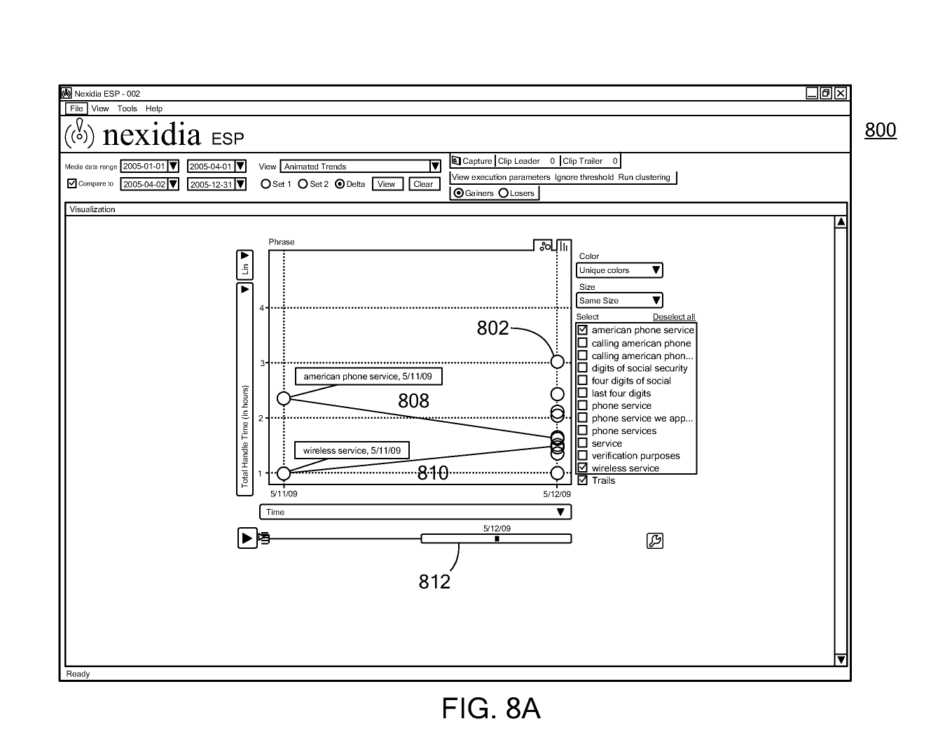

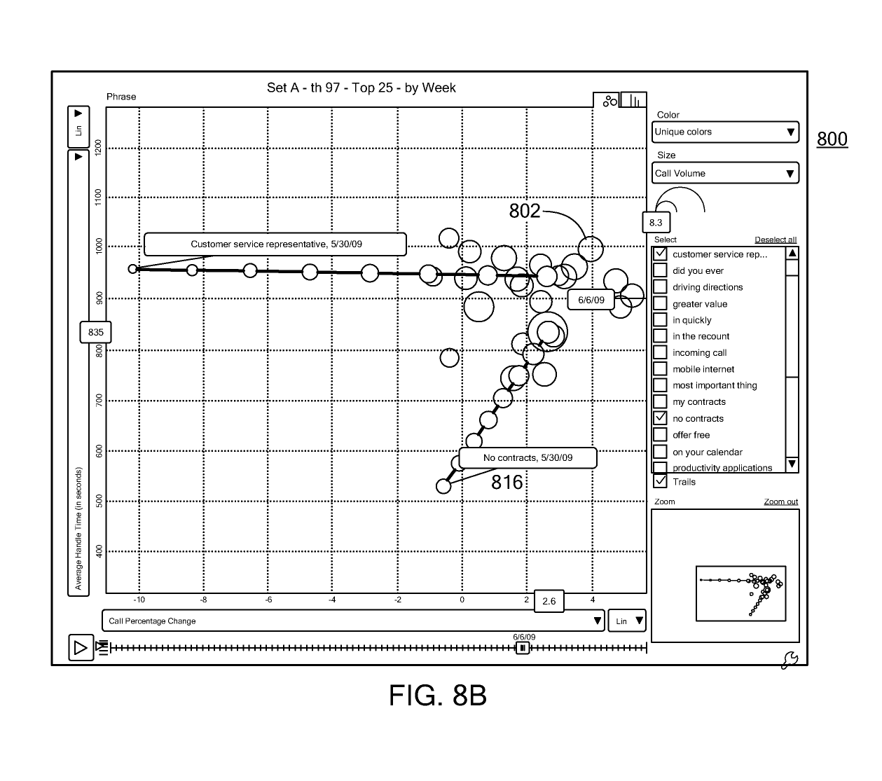

Referring to FIGS. 8A and 8B, trends in top keyphrases of interest are shown in an interactive, animated display 800. The X-axis, Y-axis, and color and size of bubbles 806 are dynamically configurable by a user to represent any of a variety of parameters. For instance, in a control center application, these parameters include a call volume, an average or total call handle time, and a call percentage or change in call percentage for a selected keyphrase of interest. A time period (e.g., a day or a week) can also be displayed on an axis.

In the example of FIG. 8A, total call handle time is plotted for two dates: May 11, 2009, and May 12, 2009. A first curve 808 shows that the total handle time for calls including the phrase “american phone service” decreased from about 1.3 hours on May 11 to about 0.6 hours on May 12. A second curve 810 shows that the total handle time for calls including the phrase “wireless service” increased from 0 hours on May 11 to about 0.5 hours on May 12. Controls 812 allow the display to be “played” in time to view, in this case, the total handle time for other dates.

In the example of FIG. 8B, average handle time is plotted versus the change in call percentage for a given keyphrase. The size of bubbles 806 corresponds to the call volume for that keyphrase. A first series of bubbles 814 corresponds to the keyphrase “customer service representative” and a second series of bubbles 816 corresponds to the keyphrase “no contracts.”

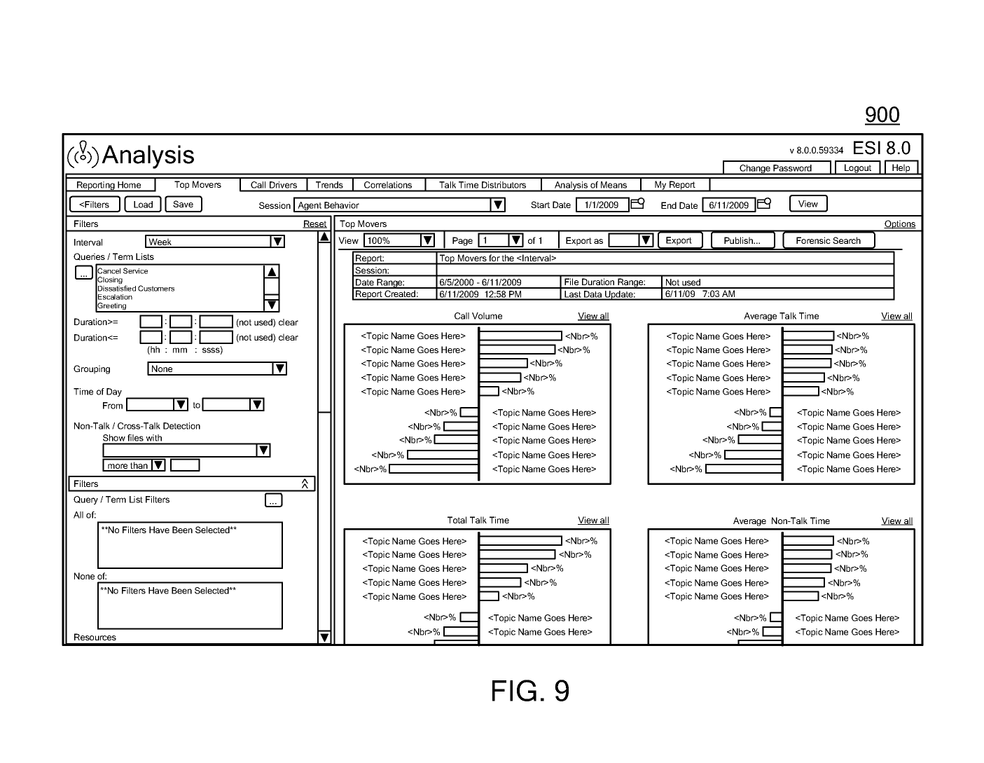

Referring to FIG. 9, a user interface 900 includes bar charts showing trends in various call parameters for selected keyphrases of interest. In this example, bar charts show percent change in call volume, average talk time, total talk time, and average non-talk time. A user of user interface 900 selects the keyphrases of interest to include in the bar charts.

### 3 Salient Pairs and Clusters of Keyphrases of Interest

### 3.1 Analysis

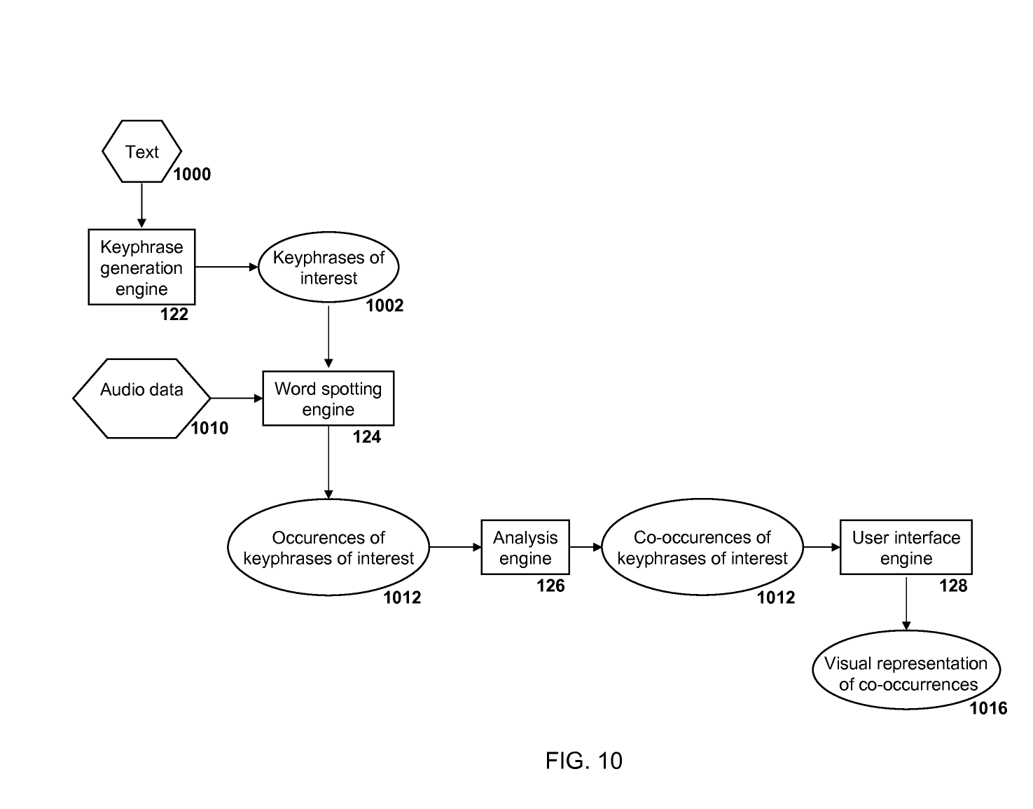

Referring to FIG. 10, audio data is analyzed to detect salient pairs of co-occurring keyphrases of interest that are spoken in close conversational proximity to each other. For instance, the keyphrase “payment method” may often be spoken along with “expiration date,” or the keyphrase “configure network” may often occur along with “network settings.” As described above, keyphrase generation engine 122 processes a text corpus 1000 to generate a list of keyphrases of interest 1002. Word spotting engine 124 then processes a set of audio data 1010, such as a PAT file, to detect putative occurrences 1012 of one or more of the keyphrases of interest 1002.

Analysis engine 126 evaluates data corresponding to the putative occurrences 1012 of keyphrases to identify co-occurrences 1012 of spoken instances of the keyphrases. For example, analysis engine 126 records a number of times a spoken instance of a first keyphrase occurs within a predetermined time range of another keyphrase. The analysis engine 126 generates a co-occurrence vector for the first keyphrase representing co-occurring keyphrases, which vector is stored for further processing. The strength of association can also be weighted by measuring the distance apart of spoken instances of two keyphrases at each instance of co-occurrence. In some embodiments, analysis engine 126 compares the co-occurrence vector for a keyphrase in a first set of audio data with a co-occurrence vector for that keyphrase in a prior set of audio data to detect trends in co-occurring keyphrases of interest, such as changes in keyphrases that form salient pairs over time. User interface engine 128 receives co-occurrence vectors and generates a visual representation 1016 of at least some of the salient pairs.

Similarly, analysis engine 126 may be configured to detect clusters of keyphrases of interest that tend to be spoken within a same conversation or within a predetermined time range of each other. As an example, a control center for a mobile phone company may receive phone calls in which a customer inquires about several models of smartphones. A clustering analysis would then detect a cluster of keyphrases of interest related to the names of smartphone models. Analysis engine may also detect trends in clusters of keyphrases, such as changes in keyphrases that form trends over a period of time.

### 3.2 Visualization

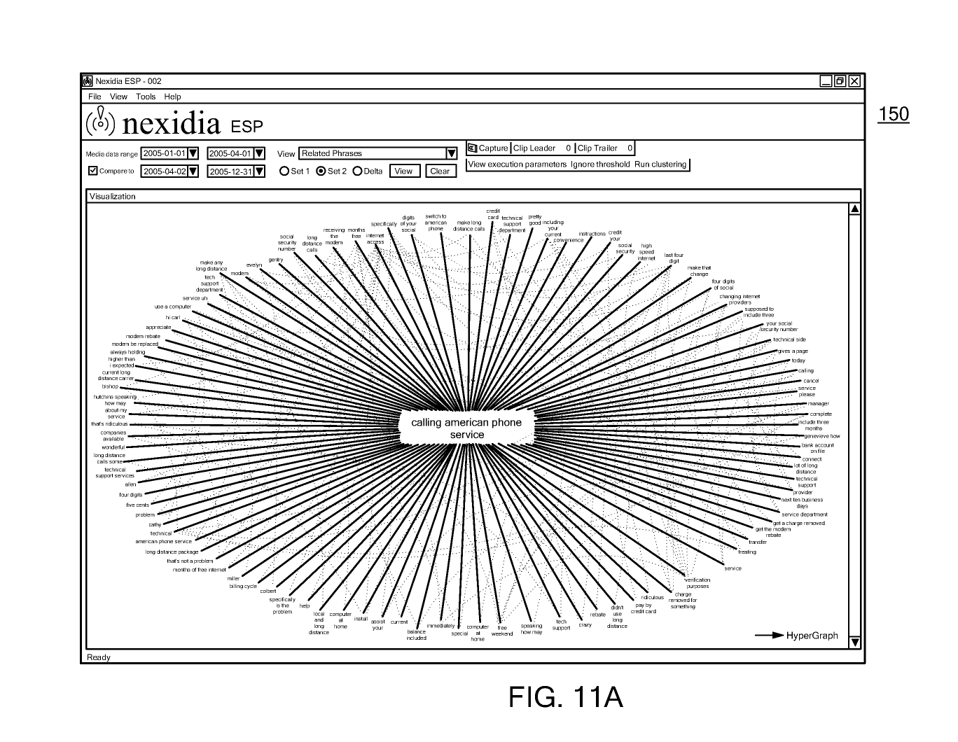

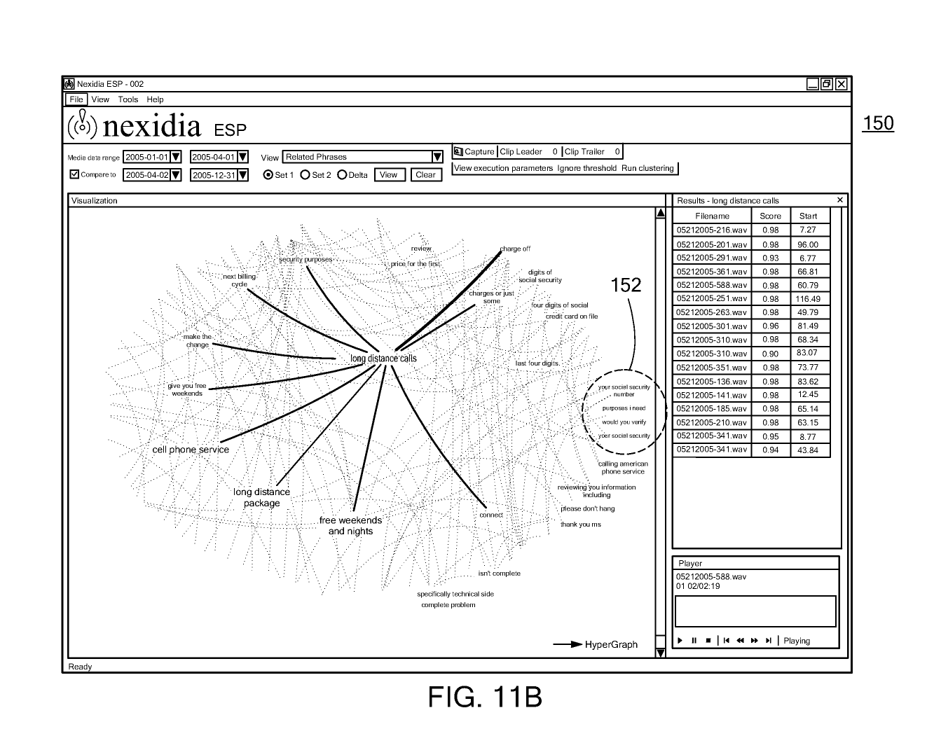

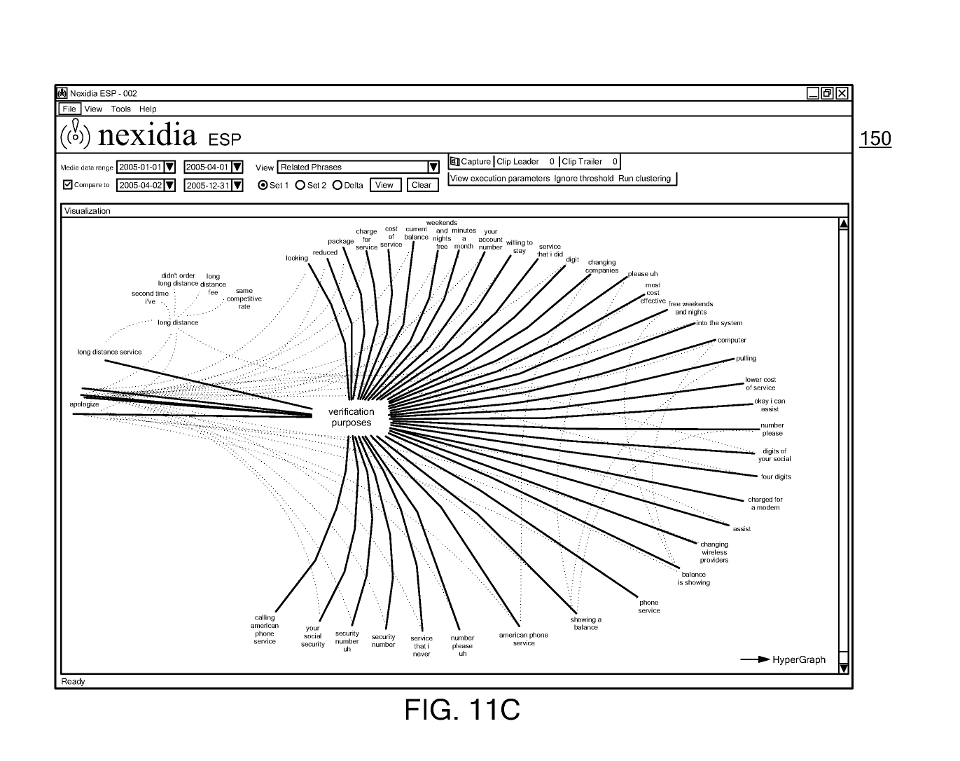

Referring to FIGS. 11A-11C, a user interface 150 displays visual representations of salient pairs and clusters of keyphrases of interest. FIG. 11A shows vectors representing salient pairs including the keyphrase “american phone service.” FIG. 11B shows vectors representing salient pairs including the keyphrase “long distance calls.” For instance, “long distance calls” is frequently spoken in close conversational proximity to the keyphrase “free weekends and nights.” A cluster 152 including the keyphrases “your social security number,” “purposes I need,” “would you verify,” and “your social security” is evident in this display. Similarly, FIG. 11C shows vectors representing salient pairs including the keyphrase “verification purposes.”

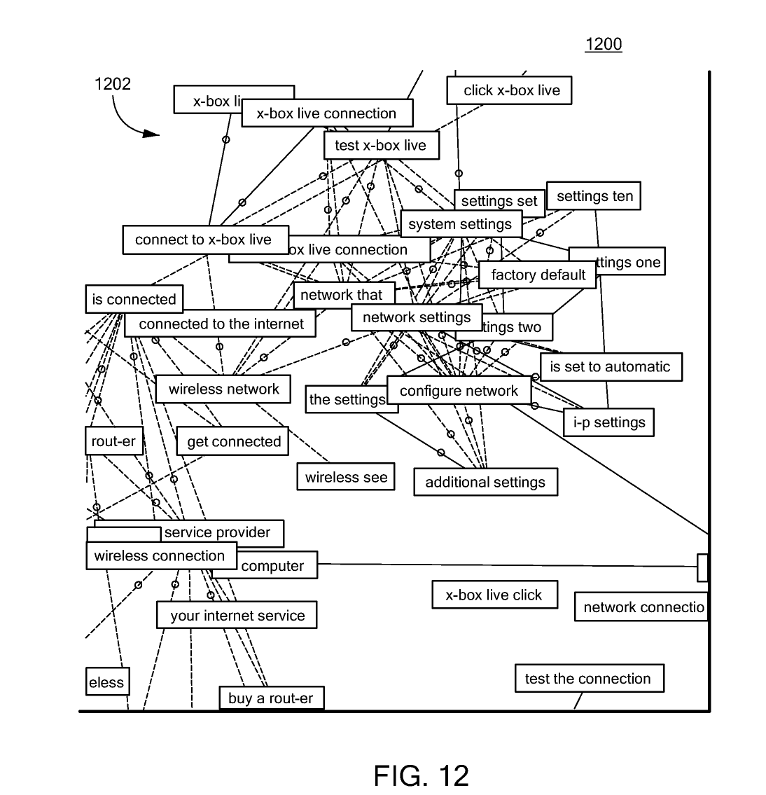

Referring to FIG. 12, another representation 1200 of salient pairs and clustering shows vectors 1202 linking co-occurring keyphrases of interest and clusters of keyphrases that tend to occur in a same conversation.

Tracking of clusters and salient pairs of co-occurring keyphrases of interest may be useful to aid a user (e.g., a control center agent) in responding to customer concerns or in generating new queries. As an example, the keyphrases “BlackBerry®” and “Outlook® Exchange” may have a high co-occurrence rate during a particular week. When a control center agent fields a call from a customer having problems using his BlackBerry®, the control center agent performs a query on the word BlackBerry®. In response, the system suggests to the control center agent that the customer's problems may be related to email and provides links to BlackBerry®-related knowledge articles that help troubleshoot Outlook® Exchange issues. More generally, tracking of clusters and salient pairs of co-occurring keyphrases of interest aids a user in identifying problem areas for troubleshooting or training

### 4 Effect of Language Model

To enable the keyphrase generation engine to more readily identify keyphrases of interest specific to a particular company or application, a custom language model (LM) may be used instead of the generic LM described above. A custom LM is developed by training with relevant textual resources such as company websites, marketing literature, and training materials. In addition, a user may provide a list of important phrases obtained from, e.g., existing taxonomy, structured queries, and listener queries.

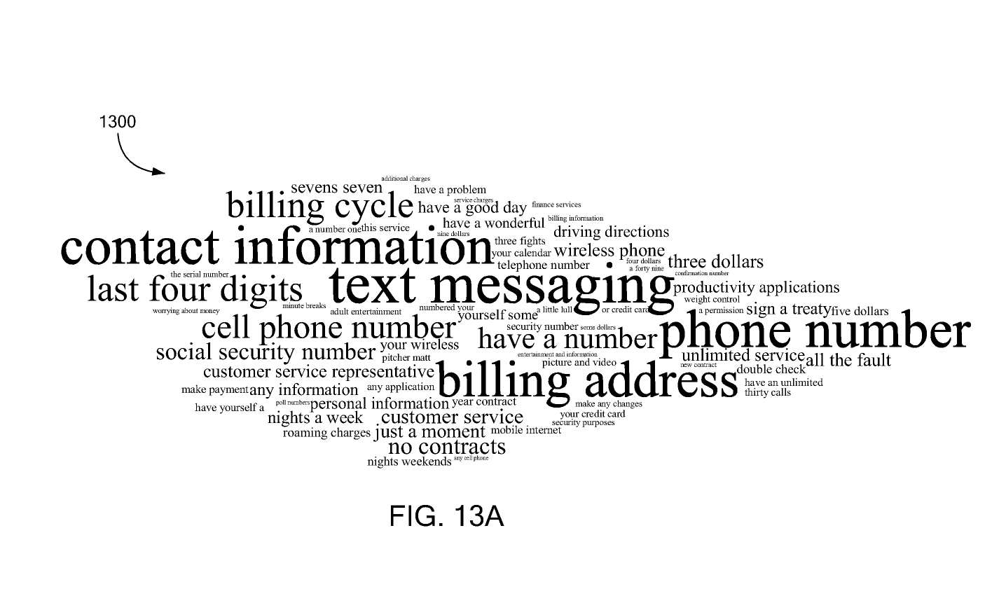

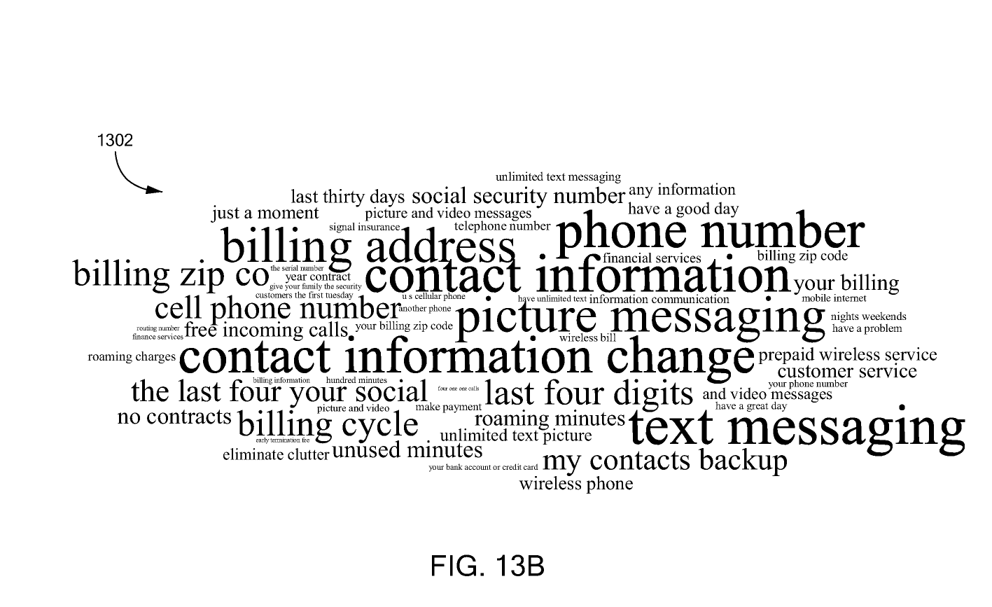

Referring to FIGS. 13A and 13B, the use of a custom language model allows more accurate detection of relevant keyphrases of interest. A generic word cloud 1300 in FIG. 13A shows top keyphrases of interest detected in a set of audio signals by using a generic LM. The keyphrases “text messaging” and “billing address” were detected most frequently. A custom word cloud 1302 in FIG. 13B shows top keyphrases of interest detected in the same set of audio signals by using a custom LM. With a custom LM, the top keyphrases of interest more accurately reflect topics relevant to the particular application, in this example a mobile phone company. For instance, keyphrases such as “picture messaging” and “contact information change” feature prominently in custom word cloud 1302 but do not appear at all in generic word cloud 1300.

The use of a custom LM to evaluate a text source increases recall over the use of a baseline LM and a standard search.

### 5 Applications

The above-discussed trend discovery techniques are generally applicable to a number of control center implementations in which various types of hardware and network architectures may be used.

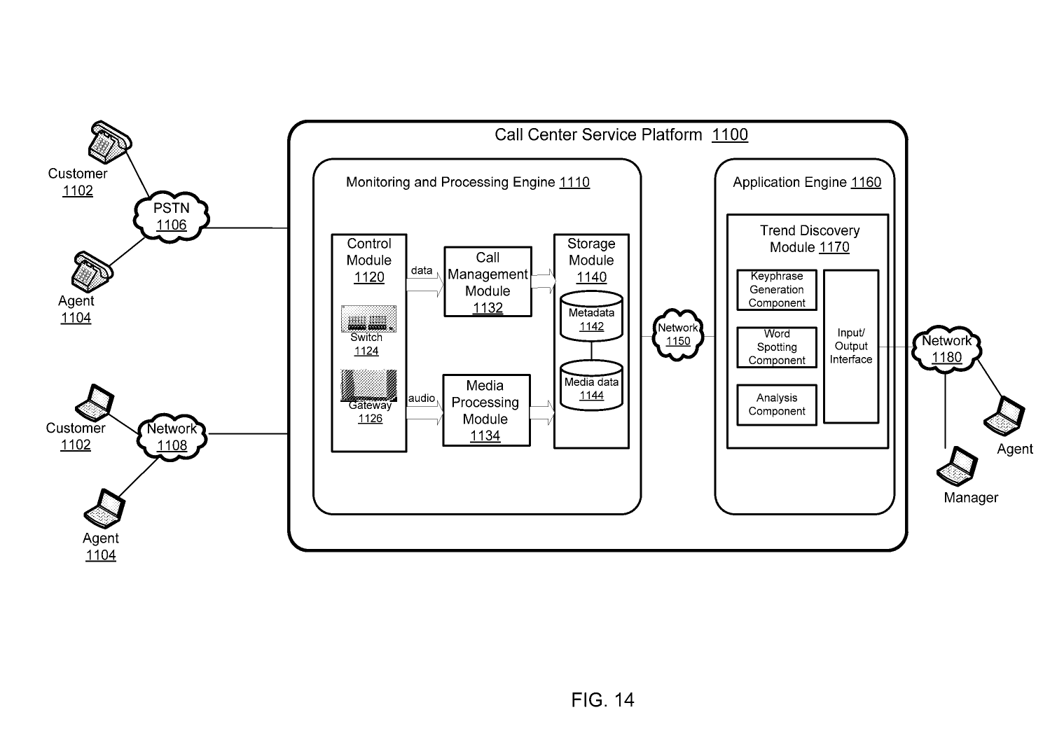

Referring to FIG. 14, a control center service platform 1100 integrates trend discovery functionality with other forms of customer interactions management. Here, the control center service platform 1100 implements at least two types of service engines. A monitoring and processing engine 1110 is configured for connecting customers and agents (for example, through voice calls), monitoring and managing interactions between those two parties, and extracting useful data from past and present interactions. Based on the extracted data, an application engine 1160 is configured for performing user-directed analyses (trend discovery) to assist management in obtaining business insights.

Traditionally, a customer 1102 contacts a control center by placing telephone calls through a telecommunication network, for example, via the public switched telephone network (PSTN) 1106. In some implementations, the customer 1102 may also contact the control center by initiating data-based communications through a data network 1108, for example, via internet by using voice over internet protocol (VoIP) technology.

Upon receiving an incoming request, a control module 1120 in the monitoring and processing engine 1110 uses a switch 1124 to route the customer call to a control center agent 1104. Once call connections are established, a media gateway 1126 is used to convert voice streams transmitted from the PSTN 1106 or from the data network 1108 into a suitable form of media data compatible for use by a media processing module 1134.

In many situations, the media processing module 1134 records voice calls received from the media gateway 1126 and stores them as media data 1144 into a storage module 1140. Some implementations of the media processing module are further configured to process the media data to generate non-audio based representations of the media files, such as phonetic audio track (PAT) files that provide a searchable phonetic representation of the media files, base on which the content of the media can be conveniently searched. Those non-audio based representations are stored as metadata 1142 in the storage module 1140.

The monitoring and processing engine 1110 also includes a call management module 1132 that obtains descriptive information about each voice call based on data supplied by the control module 1120. Examples of such information includes caller identifier (e.g., phone number, IP address, customer number), agent identifiers, call duration, transfer records, day and time of the call, and general categorization of calls (e.g., as determined based on touchtone input), all of which can be saved as metadata 1142 in the storage module 1140.

Data in the storage module 1140 can be accessed by the application engine 1160 over a data network 1150. Depending on the particular implementation, the application engine 1160 may employ a set of functional modules, each configured for a different analytic task. For example, the application engine 1160 may include a trend discovery module 1170 that provides trend discovery functionality in a manner similar to the data management system 100 described above with reference to FIG. 1. Control center agents and managers can interact with the trend discovery module 1170 to provide input and obtain analysis reports through a data network 1180, which may or may not be the same as the data network 1150 coupling the two service engines 1110 and 1160.

Note that this embodiment of control center service platform 1100 offers an integration of telecommunication-based and data-based networks to enable user interactions in different forms, including voice, Web communication, text messaging, and email. Examples of telecommunication networks include both fixed and mobile telecommunication networks. Examples of data networks include local area networks (“LAN”) and wide area network (“WAN”), e.g., the Internet, and include both wired and wireless networks.

Also, customers and agents who interact on the same control center service platform 1100 do not necessarily have to reside within the same physical or geographical region. For example, a customer located in U.S. may be connected to an agent who works at an outsourced control center in India.

In some examples, each of the two service engines 1110 and 1160 may reside on a separate server and individually operate in a centralized manner. In some other examples, the functional modules of a service engine may be distributed onto multiple hardware components, between which data communication channels are provided. Although in the example of FIG. 15, the two service engines are illustrated as two separate engines that communicate over the network 1150, in certain implementations, they may be integrated into one service engine that operates without the use of data network 1150.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

It is to be understood that the foregoing description is intended to illustrate and not to limit the scope of the invention, which is defined by the scope of the appended claims. Other embodiments are within the scope of the following claims.

What is claimed is:

1. A method comprising:
processing, by a keyphrase generation engine, data representative of text associated with one or more content sources to generate a specification of a set of keyphrases of interest;
processing, by a word spotting engine, a first set of audio signals collected during a first time period to generate first data characterizing putative occurrences of one or more keyphrases of the set of keyphrases of interest in the first set of audio signals;
evaluating, by an analysis engine, the first data to generate keyphrase-specific comparison values for the first set of audio signals;
deriving, by the analysis engine, first trending data between the first set of audio signals and a second set of audio signals based in part on an analysis of the keyphrase-specific comparison values for the first set of audio signals relative to stored keyphrase-specific baseline values; and
generating, by a user interface engine, a visual representation of at least some of the first trending data and causing the visual representation of the first trending data to be presented on a display terminal.

2. The method of claim 1, wherein the visual representation further includes trending data other than the first trending data.

3. The method of claim 1, wherein the keyphrase generation engine, the word spotting engine, the analysis engine, and the user interface engine form part of a contact center system.

4. The method of claim 3, wherein the first set of audio signals is representative of interactions between contact center callers and contact center agents.

5. The method of claim 3, wherein the display terminal is associated with a contact center user.

6. The method of claim 1, further comprising:
processing, by the word spotting engine, the second set of audio signals collected during a second time period to generate second data characterizing putative occurrences of one or more keyphrases of the set of keyphrases of interest in the second set of audio signals.

7. The method of claim 6, wherein the second set of audio signals is representative of interactions between contact center callers and contact center agents.

8. The method of claim 6, wherein the second time period is prior to the first time period, and the method further includes:
evaluating, by the analysis engine, the second data to generate the keyphrase-specific baseline values; and
storing, by the analysis engine, the keyphrase-specific baseline values in a machine-readable data store.

9. The method of claim 6, wherein the second time period is subsequent to the first time period, and the method further includes
evaluating, by the analysis engine, the second data to generate keyphrase-specific comparison values for the second set of audio signals;
deriving, by the analysis engine, second trending data between the second set of audio signals period and a third set of audio signals based in part on an analysis of the keyphrase-specific comparison values of the second set of audio signals relative to the stored keyphrase-specific baseline values; and
generating, by the user interface engine, a visual representation of at least some of the second trending data and causing the visual representation of the second trending data to be presented on a display terminal.

10. The method of claim 9, wherein the visual representation further includes trending data other than the first trending data and the second trending data.

11. The method of claim 6, wherein the second time period is subsequent to the first time period, and the method further includes
evaluating, by the analysis engine, the second data to generate keyphrase-specific comparison values for the second set of audio signals;
deriving, by the analysis engine, second trending data between the second set of audio signals and the first set of audio signals based in part on an analysis of the keyphrase-specific comparison values of the second set of audio signals relative to the keyphrase-specific comparison values for the first set of audio signals; and
generating, by the user interface engine, a visual representation of at least some of the second trending data and causing the visual representation of the second trending data to be presented on a display terminal.

12. The method of claim 11, wherein the visual representation further includes trending data other than the first trending data and the second trending data.

13. The method of claim 1, wherein the specification of the set of keyphrases of interest includes at least one phonetic representation of each keyphrase of the set.

14. The method of claim 1, wherein for each set of audio signals, the processing includes identifying time locations in the set of audio signals at which a spoken instance of a keyphrase of the set of keyphrases of interest is likely to have occurred based on a comparison of data representing the set of audio signals with the specification of the set of keyphrases of interest.

15. The method of claim 1, wherein evaluating each of the first data and the second data includes computing values representative of one or more of the following: hit count, call count, call percentage, total call duration.

16. The method of claim 1, further comprising filtering the first set of audio signals prior to processing the first set of audio signals by the word spotting engine.

17. The method of claim 16, wherein the filtering is based on one or more of the following techniques: clip spotting and natural language processing.

18. A method comprising:
processing, by a keyphrase generation engine, data representative of text associated with one or more content sources to generate a specification of a set of keyphrases of interest;
processing, by a word spotting engine, a first set of audio signals collected during a first time period to generate first data characterizing putative occurrences of one or more keyphrases of the set of keyphrases of interest in the first set of audio signals;
evaluating, by an analysis engine, the first data to identify coocurrences of spoken instances of keyphrases of the set of keyphrases of interest within the first set of audio signals; and
generating, by a user interface engine, a visual representation of at least some of the identified cooccurences of the spoken instances of keyphrases and causing the visual representation to be presented on a display terminal.

19. The method of claim 18, wherein the identified coocurrences of spoken instances of keyphrases represent salient pairs of cooccurring keyphrases of interest.

20. The method of claim 19, further comprising:
deriving, by the analysis engine, first trending data between the first set of audio signals and a second set of audio signals based in part on an analysis of the salient pairs of coocurring keyphrases of interest within the first set of audio signals relative to salient pairs of coocurring keyphrases of interest within a second set of audio signals; and
generating, by the user interface engine, a visual representation of at least some of the first trending data and causing the visual representation of the first trending data to be presented on the display terminal.

21. The method of claim 20, wherein the visual representation further includes trending data other than the first trending data.

22. The method of claim 18, wherein the identified coocurrences of spoken instances of keyphrases represent clusters of keyphrases of interest.

23. The method of claim 22, further comprising:
deriving, by the analysis engine, first trending data between the first set of audio signals and a second set of audio signals based in part on an analysis of the clusters of keyphrases of interest within the first set of audio signals relative to clusters of coocurring keyphrases of interest within a second set of audio signals; and
generating, by the user interface engine, a visual representation of at least some of the first trending data and causing the visual representation of the first trending data to be presented on the display terminal.

24. The method of claim 23, wherein the visual representation further includes trending data other than the first trending data.

25. The method of claim 18, wherein the keyphrase generation engine, the word spotting engine, the analysis engine, and the user interface engine form part of a contact center system.

26. The method of claim 24, wherein the first set of audio signals is representative of interactions between contact center callers and contact center agents.

27. The method of claim 24, wherein the display terminal is associated with a contact center user.

28. The method of claim 18, wherein evaluating the first data comprises:
recording a number of times a spoken instance of a first keyphrase of the set of keyphrases of interest occurs within a predetermined range of another keyphrase of the set of keyphrases of interest;
generating a vector for the first keyphrase based on the recording; and
storing the generated first keyphrase vector in a machine-readable data store for further processing.

29. The method of claim 28, further comprising:
repeating the recording, vector generating, and storing actions for at least some other keyphrases of the set of keyphrases of interest.
